(19) United States
(12) Patent Application Publication
(10) Pub. No.: US 2015/0332298 A1
(43) Pub. Date: Nov. 19, 2015

(54) PRICE MATCHING IN OMNI-CHANNEL RETAILING

(71) Applicant: International Business Machines Corporation, Armonk, NY (US)

(72) Inventors: Markus R. Ettl, Ossining, NY (US); Pavithra Harsha, Yorktown Heights, NY (US); Shivaram Subramanian, Danbury, CT (US); Joline Ann Villaranda Uichanco, White Plains, NY (US)

(73) Assignee: INTERNATIONAL BUSINESS MACHINES CORPORATION, Armonk, NY (US)

(21) Appl. No.: 14/276,572

(22) Filed: May 13, 2014

(51) Int. Cl. G06Q 30/02

(52) U.S. Cl. CPC G06Q 30/0206

(57) ABSTRACT

Price matching strategies for a seller selling products using one or more sales channels and facing competition from omni-channel competitors in marketplace may be provided. For a product and channel, a subset of candidate competitors by product and channel may be identified. For a product, channel, candidate competitor, a value-at-risk metric is computed that represents the seller's value in the sales channel that is at risk to a competitor's price change. Based on the value-at-risk metric, one or more products for price matching against the candidate competitors may be identified. A price for the identified product may be computed that is within a competitive range.

### FIELD

The present application relates generally to computers, and computer applications, and more particularly to computer-implemented pricing of products sold via multiple channels by multiple sellers.

### BACKGROUND

Over the past few years, there have been sweeping changes in the retail industry that have been affecting all retailers. These changes are the emergence of large e-commerce retailers and the advent of the mobile platform where customers can compare online prices with ease. A known e-commerce retailer allows customers to scan bar codes in brick-and-mortar stores and compare prices instantly with its online store. The ease of comparing online prices from different e-commerce retailers led to an emerging shopping trend called “showrooming” where customers visit brick-and-mortar stores to try products and purchase from a competing e-commerce retailer with a lower price. For example, mobile phone owners use their mobile phones while they were in a store to look up the price of a product online to see if they could get a better price somewhere else. It has also been found that there has been an increase in customers who purchased a product from a competitor while in a retail store.

Consequently, many large retailers have been implementing a price-match strategy as a key marketing tactic to attract shoppers. Price-matching is a practice where a retailer offers to sell a product for the same price (or close to the price) that a competing retailer is offering for the same product. In most implementations of a price-match strategy, the retailer will advertise that it will price-match against a fixed set of key competing retailers for all products with possibly some exclusions (e.g. some product categories might be excluded). Known large retailers offer price-matching by implementing one or more different strategies. The following summarizes the price-match strategy implementations in a few large retailers:

One known retailer's brick-and-mortar stores price-match only online prices, only matching prices to the specific websites of other retailers. Another known retailer's brick-and-mortar stores price-match a fixed set of electronics stores, requiring a customer service representative to approve the price match. Yet another known retailer only price-matches to only one other specific online retailer's prices. Still another known retailer price-matches against retailers in close geographical proximity that also have online published prices. A known retailer further employs a website feature that compares prices of every product on the receipt to a database of advertised prices of competitors, price-matching to competitive stores based on geographic location, but not on online retailers. That feature, however, does not include purchases made on the online store of the retailer or general merchandise such as clothing or electronic gadgets.

### BRIEF SUMMARY

A method may be provided for price matching in a marketplace with a first seller and one or more second sellers selling one or more products. The method in one aspect may comprise obtaining a first seller's sales data and price data associated with said one or more products in one or more sales channels. The method may also comprise obtaining one or more second sellers' price data associated with said one or more products in said one or more sales channels. The method may further comprise calibrating a demand model based on the first seller's sales data and price data associated with said one or more products in one or more sales channels and said one or more second sellers' price data associated with said one or more products in said one or more sales channels. The method may also comprise computing simultaneously cross-competitor price elasticities associated respectively with said one or more second sellers based on the demand model. The method may further comprise identifying one or more candidate competitors in the marketplace for price matching based on the cross-competitor price elasticities. The method may also comprise computing a value at risk attributed to said one or more candidate competitors. The method may further comprise determining one or more products for price matching based on the value at risk.

A system for price matching in a marketplace with a first seller and one or more second sellers selling one or more products, in one aspect, may comprise a hardware processor and a storage device. The storage device may be operable to store a first seller's sales data and price data associated with said one or more products sold in one or more sales channels, the storage device further operable to store one or more second sellers' price data associated with said one or more products sold in said one or more sales channels. The hardware processor may be operable to calibrate a demand model based on the first seller's sales data and price data associated with said one or more products in one or more sales channels and said one or more second sellers' price data associated with said one or more products in said one or more sales channels. The hardware processor may be further operable to compute simultaneously cross-competitor price elasticities associated respectively with said one or more second sellers based on the demand model. The hardware processor may be further operable to identify one or more candidate competitors in the marketplace for price matching based on the cross-competitor price elasticities. The hardware processor may be further operable to compute a value at risk attributed to said one or more candidate competitors. The hardware processor may be further operable to determine one or more products for price matching based on the value at risk.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a method of price-matching in the presence of multiple competitors in an omni-channel marketplace in one embodiment of the present disclosure.

FIG. 2 is a block diagram showing the components that may implement a methodology of the present disclosure for price matching and price optimization in one embodiment.

FIG. 3 illustrates an example visualization that shows revenue-at-risk displayed by product, sales channel, and competitor.

FIG. 4 illustrates another example visualization that shows revenue-at-risk contributed by each sales channel and competitor for a retailer's product category.

FIG. 5 illustrates a schematic of an example computer or processing system that may implement a price matching system in one embodiment of the present disclosure.

### DETAILED DESCRIPTION

The inventors in the present application have recognized the increasing importance of price strategies for remaining competitive in today's omni-channel environment, where there is increasing price transparency across competing retailers and across the online and brick-and-mortar sales channels. Despite its prevalence, however, price-matching strategy is difficult to implement in an omni-channel retail environment due to several issues. First, many large retailers have a massive breadth of products. Second, each product or product category in a retailer's assortment might have a different set of key competing retailers, both brick-and-mortar competitors and online competitors. Therefore, there are several business challenges for a retailer selling a breadth of products operating in an omni-channel environment with multiple competing retailers: (i) to identify which product or product category should be price-matched, (ii) to identify the key competitors to be price-matched against, (iii) to determine the prices at which the products should be offered, and (iv) to determine whether the price-match strategy should be different in each of the retailer's sales channels.

A method for price matching in omni-channel retailing is disclosed. In one aspect, the method systematically identifies price-matching strategies for a retailer selling a plurality of products using one or more sales channels and facing competition from a plurality of omni-channel competitors in marketplace. For each product and channel, the method in one embodiment can isolate a subset of key competitors by product and channel, from any number of competitors. For each (product, channel, key competitor) triplet, the method in one embodiment computes a “value-at-risk” metric, which represents the retailer's value (i.e., revenue, sales volume, or profit) in the sales channel that is at risk to a competitor's price changes. A “value-at-risk” metric is computed that uses as input the sales history, price history, competitor price history from a plurality of competitors, and other transactional data. The computed value-at-risk metric in one embodiment also takes into account the joint impact of all the key-competitive effects on the retailer's sales by channel and product. A triplet with high value-at-risk is a candidate product for price matching against the key competitor in the sales channel.

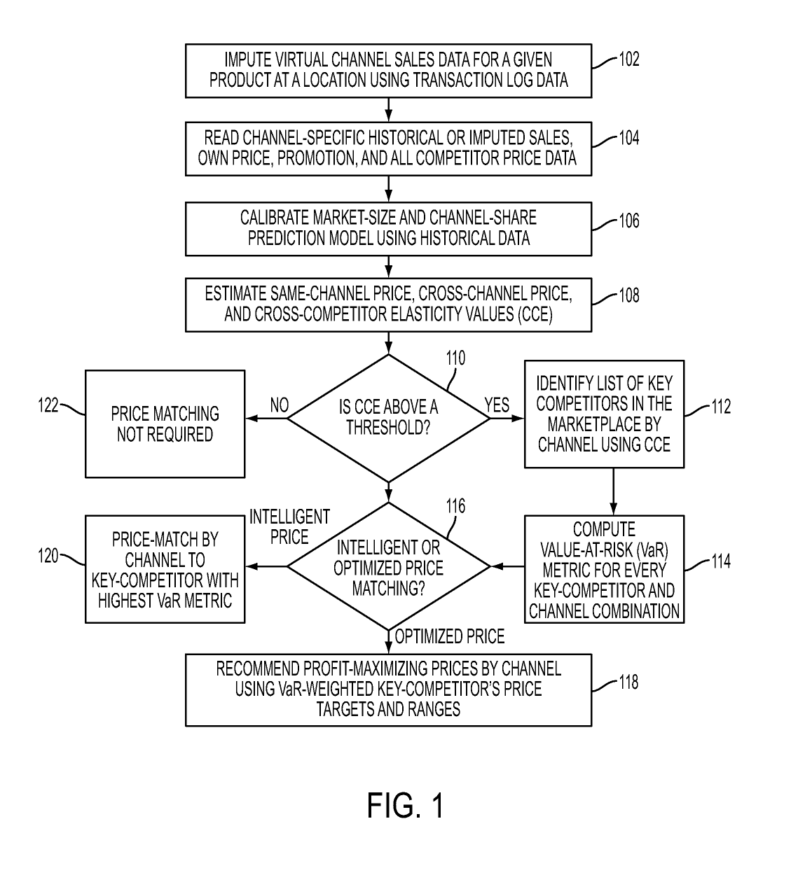

FIG. 1 is a flow diagram illustrating a method of price-matching in the presence of multiple competitors in an omni-channel marketplace in one embodiment of the present disclosure. At 102, virtual channel sales data of a retailer (also referred to as a first seller) for a given product at a location is imputed using transaction log data. Virtual channel refers to online channels such as web sites, mobile applications, and social applications via which sales transactions may be performed. The transaction log data has records of sales transactions with location identifiers in the one or more virtual channels. For example, sales transactions may contain itemized sales data such as one or more items or products sold, price, date of the sales, location and other sales information, e.g., that a purchaser might see on a sales receipt.

At 104, channel-specific historical or imputed sales data associated with the retailer (e.g., other sales channels than the virtual channels referred to at 102), the retailer's own price data, the retailer's promotion data, and all competitor price data (also referred to as one or more second seller's price data) are read or obtained, e.g., from available database of data. In one aspect, the method of the present disclosure need not have the competitor's actual sales data; rather, the method may use the competitor's price data.

At 106, market-size and channel-share prediction model is calibrated using the data obtained at 102 and 104. The prediction model calibration is further described in detail with reference to Equations (1)-(7) as an example.

At 108, the method estimates the retailer's (first seller's) same-channel price elasticity value, cross-channel price elasticity values, and cross-competitor elasticity values associated with one or more competitors (one or more second sellers) from sales history, price history, competitor price history from one or more competitors, and other transactional data, e.g., obtained at 102 and 104, and using the prediction model calibrated at 106. Same-channel price elasticity refers to the amount of loss (or gain), e.g., percentage loss (or gain) in the retailer's sales volume through a channel due to a unit (e.g., 1%) decrease (or increase) in the retailer's price in that channel. Cross-channel price elasticity refers to the amount of loss (or gain), e.g., percentage loss (or gain) in the retailer's sales volume through a channel due to a unit (e.g., 1%) decrease (or increase) in the retailer's price in a different channel. The retailer's same-channel price elasticity and cross-channel price elasticity values may be used for a demand model in optimized price matching scenario at 118. Cross-competitor price elasticity represents the amount of loss (or gain), e.g., percentage loss (or gain) in the retailer's sales volume through a channel due to a unit (e.g., 1%) decrease (or increase) of the competitor price through the same channel or a different channel. In one embodiment of the present disclosure, the cross-competitor price elasticities are calculated to account for the joint impact of all the competitive effects to the retailer's sales. The processing at 108 is performed for each of the retailer's (product, channel) combinations that are being considered. For example, at 108, cross-competitor price elasticities associated with one or more competitors (second sellers) may be computed simultaneously based on the demand model. Example computation of a cross-competitor elasticity value (CCE) is described below with reference to Equation (8). For instance, a log-likelihood function that has all competitor prices (for competitors being considered) may be used to simultaneously compute the cross-competitor price elasticities for those competitors.

Based on the cross-competitor price elasticities, one or more candidate competitors in the marketplace for price matching may be identified. For example, at 110, it is determined whether the one or more cross-competitor elasticity values computed at 108 is considered to be significant. Whether an elasticity value is significant may be determined based on a predetermined or defined criterion such as a threshold value, e.g., if the elasticity value is above a defined threshold value.

If the elasticity value meets the criterion, at 112 a list of competitors (second sellers) by channel in a marketplace is identified using the computed elasticity values (those second sellers associated with the cross-competitor price elasticities that meet the criterion at 112). Otherwise at 122, price matching need not be performed. Thus, in one embodiment, for each (product, channel) combination, the method isolates a set of competitors (referred to herein also as key competitors for the sake of explanation only) from any number of competitors, which are the competitors whose prices have significant effect on the retailer's sales, determined by the competitor price elasticities. Significance of effect of competitor's price may be determined by a defined threshold or criterion.

At 114, for every competitor and channel combination for a product identified at 112 (also referred to as candidate competitors), a value-at-risk (VaR) metric is computed. For each of the key competitors of the specific (product, channel) identified using cross-competitor price elasticities, the method then computes “value-at-risk” metrics. The value-at-risk metric for a (product, channel, competitor) triplet represents the retailer's value (e.g., revenue, sales volume, profit) from sales of the product through the channel that is at risk to the competitor's price changes.

One or more products for price matching may be determined based on the value-at-risk. For instance, a triplet with high value-at-risk is a candidate product to be price matched against the competitor in the sales channel. Whether the value-at-risk is high may be determined based on another threshold value. For example, if the value-at-risk exceeds a threshold value, the value-at-risk may be determined as being high.

The value-at-risk information may be used in a number of different ways. For example, in one embodiment of the method, the retailer can choose how it uses the value-at-risk information. One option is to exactly match competitor prices for candidates that have a high value-at-risk. Another option is to optimize a product's prices by maximizing profit but with a penalty whenever prices deviate from the key competitor (candidate competitor) prices (penalties are weighed by the value-at-risk metric so that the prices chosen will deviate less from competitors with higher value-at-risk). Thus, at 116, it is determined as to whether the price matching may be intelligent or optimized price matching. If optimized price matching is to be performed, at 118, the method may recommend profit-maximizing prices by channel using VaR-weighted key-competitor's (candidate competitor's) price targets and ranges. If intelligent price matching is to be performed, at 120, price may be matched by channel to the key-competitor (candidate competitor) with highest VaR metric.

### Demand Model

The following describes a demand model that is calibrated or estimated, e.g., at 106 in FIG. 1. Consider an omni-channel retailer operating in M channels. Let Zₘ be the vector of demand attributes (e.g., price, promotion, seasonality, competitor prices in the same or other channel) for a product sold in channel m∈M . Let Z=└Z₁, Z₂, . . . , Zₘ┘ be the corresponding matrix of attributes for all channels where the notation |.| refers to the cardinality of a set. Let Dₘ(Z) be the vector of demands originating from a location in all the channels. We refer to this as the omni-channel demand model because we allow the demand in a specific channel to depend on the attributes in other channels so that we account for cross-channel interactions. The term location is broadly used and it can be any level in the location hierarchy of the retailer (e.g., a cluster of zip codes served by a store or a cluster of stores, i.e., a zone).

In deciding the specific class of the demand model, one has a multiple alternatives depending on the features it captures as well as the ease of estimation. An embodiment discussed below are the attraction demand models. They are demand functions used to model consumer choice in marketing, economics and in revenue management. They generalize the well-known multinomial logit (MNL) and the multiplicative competitive interaction (MCI) demand models. Other alternatives to demand models include some of the following options: (a) the scan-pro demand model that explicitly capture pair-wise cross elasticities including complementary effects; (c) the hybrid demand model that combines the scan pro for market size and attraction demand model for market share.

In one embodiment of the method of the present disclousre, we use attraction demand models to model the channel purchase choice of a consumer in an omni-channel environment. In particular, we assume it has the following form:

$$\begin{matrix}{D}_{m} ( Z ) = MarketSize * \begin{matrix}MarketShare \\ ofChannelm\end{matrix} & ( 1 ) \\ = τ \frac{{f}_{m} ( {Z}_{m} )}{1 + {\sum }_{{m}^{′} ∈ M} {f}_{{m}^{′}} ( {Z}_{{m}^{′}} )} & ( 2 )\end{matrix}$$

where τ is the market size of customers in the location under consideration and fₘ(Zₘ) is the attraction function of customers in the location to channel m. Some examples of these attraction functions are

$${f}_{m} ( {Z}_{m} ) = {e}^{{a}_{m} + {b}_{m}^{T} {Z}_{m}}$$

in the case of the MNL demand model and fₘ(Zₘ)=aₘΠᵢZₘᵢ^{b}^{ₘᵢ} in the case of the MCI demand model.

An attraction demand model is often used in practice to model choice because it has fewer coefficients to evaluate than its counterparts such as the scan pro models (e.g., additive, exponential or power models). In particular, the number of coefficients in the attraction demand model is O(K) for K choices as opposed to O(K²) in the scan-pro demand model.

To estimate this demand function, historical sales data originating from each channel and location is used. Estimating an attraction demand model from sales data requires the knowledge of the lost sales component which is mathematically:

$$τ \frac{1}{1 + {\sum }_{{m}^{′} ∈ M} {f}_{{m}^{′}} ( {Z}_{{m}^{′}} )} .$$

Lost sales is unknown in many applications but methods like Expectation-Maximization (EM) technique or the 2-step approach have been proposed and used in practice to overcome this challenge. In both these methods the attraction model is itself fitted based on a maximum-likelihood approach.

Our method employs the maximum-likelihood approach with regularization. Suppose that there are N historical channel demand data and historical channel demand attributes data (for exposition purposes, we assume that the observations are demand and not sales). We demonstrate demand estimation in the case of the MNL demand model. Let yₖₘ be the k-th historical demand data in channel m. Let Zₖₘ be the vector of k-th historical demand attributes data in channel m. Define

$$\begin{matrix}{π}_{k m} = \frac{{e}^{{a}_{m} + {b}_{m}^{T} {Z}_{k m}}}{1 + {\sum }_{{m}^{′} ∈ M} {e}^{{a}_{{m}^{′}} + {b}_{{m}^{′}}^{T} {Z}_{k {m}^{′}}}} & ( 3 ) \\ {π}_{k 0} = \frac{1}{1 + {\sum }_{{m}^{′} ∈} {e}^{{a}_{{m}^{′}} + {b}_{{m}^{′}}^{T} {Z}_{k {m}^{′}}}} & ( 4 )\end{matrix}$$

where πₖₘ represents the market share of channel m of an MNL demand model with parameters (a,b) for the k-th historical demand attributes data. πₖ₀ represents the market share that is lost to the retailer (either does not purchase or purchases from competitors) under the same MNL demand model for the k-th historical demand attributes data.

The likelihood function for the MNL model is proportional to:

$$L ( a , b \vert y ) = {\prod }_{k = 1}^{N} {\prod }_{m ∈ \{ 0 , M \}} {( {π}_{k m} )}^{{y}_{ k m}} \qquad ( 5 )$$

With algebraic manipulations and taking the natural log on both sides of the equation gives the log-likelihood function for the MNL model:

$$l ( a , b ) = {\sum }_{k = 1}^{N} ( {\sum }_{m ∈ M} {y}_{k m} ( {a}_{m} + {b}_{m}^{T} {Z}_{k m} ) - {τ}_{k} log ( 1 + {\sum }_{m ∈ M} {e}^{{a}_{m} + {b}_{m}^{T} {Z}_{k m}} ) ) \qquad ( 6 )$$

We estimate the MNL demand model parameters by maximizing the log-likelihood function with elastic net regularization. In elastic net regularization, there is a penalty imposed for a rich model (i.e., it favors more parameters that are equal to zero).

$${max}_{a , b} \{ l ( a , b ) - {λ}_{1} {\sum }_{m ∈ M} ( \vert {a}_{m} \vert + {‖ {b}_{m} ‖}_{1} ) - {λ}_{2} {\sum }_{m ∈ M} ( {\vert {a}_{m} \vert}^{2} + {‖ {b}_{m} ‖}_{2}^{2} ) \} , \qquad ( 7 )$$

where λ₁, λ₂ are tuning parameters to determine the weights of the penalties. With regularization, only the demand attributes that best explain the product's demand would have nonzero parameters. Hence, even if there are many competitor prices used as demand attributes to estimate the model, only the key competitors will be isolated by the parameter estimation. Briefly, Eq. (7) solves for a and b values that maximize the term within the brackets ({ . . . }).

### Identifying Key Competitors

The following describes computing price elasticities and identifying key competitors in one embodiment of the present disclosure, e.g., referred to above with reference to 108, 110 and 112 in FIG. 1.

Let pⱼ be the price offered by competitor j for a product that the retailer is selling through a sales channel m. (Here, the competitor price may or may not be offered in the same channel m. In fact, the same retail outlet operating in two channels are considered as two different competitors for the retailer in channel m. For example for the online sales channel of retailer A, retailer B′s brick and mortar store and retailer B's dot com (online) store are both considered as competitors). Note that pⱼ is one of the attributes of demand in channel m that we denoted by Zₘ. Using the estimated omni-channel demand model we compute the cross-competitor price elasticities as follows:

$${ɛ}_{mj} = \frac{\partial {D}_{m} ( Z )}{\partial {p}_{j}} \frac{{p}_{j}}{{D}_{m} ( Z )} ∀ m ∈ M , j ∈ J . \qquad ( 8 )$$

This number (εₘⱼ) provides the percentage decrease in demand through sales channel m (and the location under consideration), if the price of the competitor j is increased by one percent. For example, it can refer to the percentage increase in brick-and-mortar demand for a product at a store location, if the online or brick price of the same product with a competitor is increased by one percent. More generally, the competitor price elasticity provides a change in demand of a retailer's product responsive to a competitor's price change of the same or similar product.

Cross-competitor elasticity computations for an MNL attraction demand model:

The MNL demand model has the following form when all the other attributes but the competitor price are fixed:

$${D}_{m} ( {p}_{j} ) = τ \frac{{f}_{m} ( {p}_{j} )}{1 + {\sum }_{{m}^{′} ∈ M} {f}_{{m}^{′}} ( {p}_{j} )} where \\ {f}_{m} ( {p}_{j} ) = {e}^{{a}_{m} + {b}_{m} {p}_{j}} ∀ m ∈ M \qquad ( 9 )$$

Cross-competitor price elasticities are

$${ɛ}_{mj} = {p}_{j} \frac{{b}_{m} + {\sum }_{{m}^{′} ∈ M} {f}_{{m}^{′}} ( {p}_{j} ) ( {b}_{m} - {b}_{{m}^{′}} )}{1 + {\sum }_{{m}^{′} ∈ M} {f}_{{m}^{′}} ( {p}_{j} )} \qquad ( 10 )$$

Equation (10) above is derived from Equation (8) using a specific demand model (MNL demand).

Identifying Candidate Competitors to Price-Match using the Value-at-Risk Metric

The following description discuss how to identify the candidate competitors to price-match in one embodiment. Cross-competitor price elasticities represent the percentage loss (or gain) in the retailer's sales volume due to a unit (e.g., 1%) decrease (or increase) of the competitor price. The above description provided that the magnitude of cross-competitor price elasticities for a given product determines the set of key competitors (from a multitude of competitors) that have an impact on a product's sales volume in a given channel. These key competitors may or may not be prime candidates for a price-match strategy. For example, if a product has a low annual sales volume in a given sales channel and exhibits a high elasticities to a specific competitor price, it might not be a good candidate because the product is not a high-revenue generating product for the retailer. We introduce a new metric called “value-at-risk” that can be used to directly compare a retailer's plurality of (product, channel, competitor) triplets to find candidates for price-matching. The value-at-risk of a (product, channel, competitor) triplet represents the retailer's value from sales of the product through the channel that is at risk to the competitor's price decreases. The retailer's value used in value-at-risk can be annual revenue, sales volume, profit, or any other key performance indicator.

The following description shows how to compute the value-at-risk metric in one embodiment, e.g., referred to at 114 in FIG. 1. Let εᵢₘⱼ be the cross-competitor price elasticity of product i through sales channel m to competitor j calculated in the previous section. Let pᵢₘ be the retailer's average price for product i through sales channel m. Suppose product i has product cost of cᵢ. Let Dᵢₘ, Rᵢₘ, and Πᵢₘ be the retailer's annual sales volume, annual revenue, and annual profit from product i through sales channel m.

### Computing the Value-at-Risk Metric

Suppose that competitor j decides to decrease its average prices for product i by 1%. Then the retailer will expect to have a lower sales volume due to customers switching to buy from competitor j. The annual sales volume that the retailer expects to lose due to a 1% decrease in competitor prices is called the volume-at-risk. The retailer's volume-at-risk of product i through sales channel m from competitor j, denoted as VolaRᵢₘⱼ, is given by:

VolaRᵢₘⱼ=εᵢₘⱼDᵢₘ (11)

Suppose that competitor j decides to decrease its average prices for product i by 1%. Then due to a lower sales volume, the retailer will expect to observe a lower revenue from sales of product i. The annual revenue that the retailer expects to lose due to a 1% decrease in competitor prices is called the revenue-at-risk. The retailer's revenue-at-risk of product i through sales channel m from competitor j

RaRᵢₘⱼ=εᵢₘⱼDᵢₘpᵢₘ (12)

Suppose that competitor j decides to decrease its average prices for product i by 1%. Then due to a lower sales volume, the retailer will expect to observe a lower profit from sales of product i. The annual profit that the retailer expects to lose due to a 1% decrease in competitor prices is called the profit-at-risk. The retailer's profit-at-risk of product i through sales channel m from competitor j

PaR=εᵢₘⱼDᵢₘ(pᵢₘⱼ−cᵢ) (13)ₜᵢₘₑ

Note that the retailer's value-at-risk (volume-at-risk, revenue-at-risk, profit-at-risk) can also be specified by product category, (product category, channel), (product category, competitor), or (product category, channel, competitor). Suppose VaRᵢₘⱼ is the value-at-risk (can be volume-at-risk, revenue-at-risk, profit-at-risk) of product i through sales channel m from competitor j. Let PC be the set of products in a particular product category (e.g., kitchen appliances). Furthermore let M be the set of all the retailer's sales channels, and J be the set of all competitors. Then the retailer's value-at-risk in the product category due to a 1% decrease in all competitors' prices is:

$${\sum }_{i ∈ PC} {\sum }_{m ∈ M} {\sum }_{j ∈ J} {VaR}_{imj} \qquad ( 14 )$$

The retailer's value-at-risk in the product category through sales channel m due to a 1% decrease in all competitors' prices is:

$${\sum }_{i ∈ PC} {\sum }_{j ∈ J} {VaR}_{imj} \qquad ( 15 )$$

The retailer's value-at-risk in the product category due to a 1% decrease in competitor j prices is:

$${\sum }_{i ∈ PC} {\sum }_{m ∈ M} {VaR}_{imj} \qquad ( 16 )$$

The retailer's value-at-risk in the product category through sales channel m due to a 1% decrease in competitor j prices is:

$${\sum }_{i ∈ PC} {VaR}_{imj} \qquad ( 17 )$$

In another aspect, a value-at-risk metric may be computed as a weighted average of volume-at-risk, revenue-at-risk, profit-at-risk, normalized as needed.

Intelligent Price-Matching through the Value-at-Risk Metric

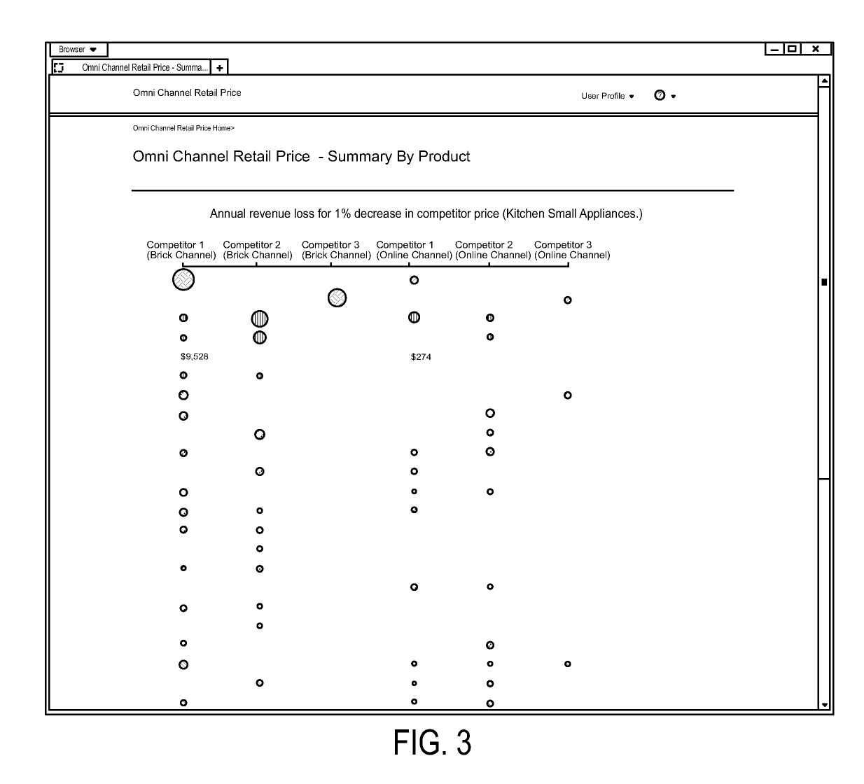

In this section, we demonstrate our method of using the value-at-risk metric for price-matching. FIG. 3 is an embodiment in which the revenue-at-risk is displayed as a bubble chart by (product, channel, competitor). Each column corresponds to a (channel, competitor) combination. Each row corresponds to a product. The size of the bubble is proportional to the magnitude of the revenue-at-risk. A large bubble for a specific (product, channel, competitor) signifies that the retailer is at-risk to lose a large revenue in the product's sales through the channel if the competitor decreases prices. The bubble chart is used to determine which (product, channel) to match to which competitor according to the size of the bubble. Bubble sizes exceeding a specified threshold are (product, channel) combinations to price-match to the competitor.

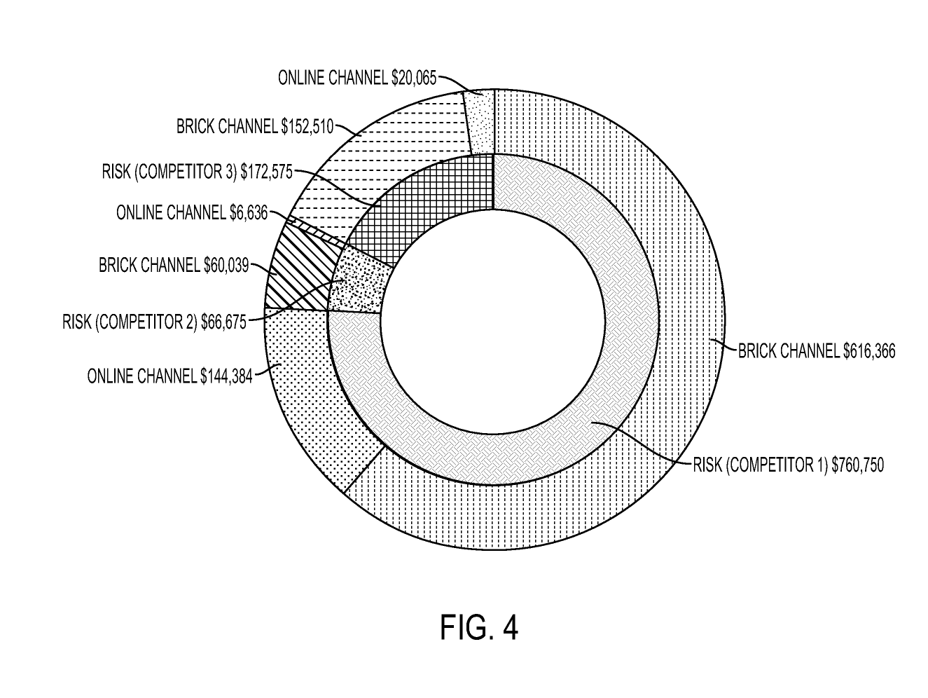

FIG. 4 is another embodiment in which the revenue-at-risk is displayed as a donut chart for one product category. The total revenue-at-risk due to competition for this product category is $1 million. In FIG. 3, the size of the segments of the inner level of the circle represents the relative contribution by each competitor to the product category's revenue-at-risk. The segments of the outer level further splits the contribution to the product category's revenue-at-risk by (channel, competitor). The donut chart is used to determine a unified price-matching scheme for each product category. If a (channel, competitor) has a large contribution to the product category's revenue-at-risk, then a unified price-matching scheme is to match prices of all products in that product category sold through the sales channel to the competitor.

Based on the value-at-risk metrics and the key competitors identified by the retailer, the retailer can alternatively decide to set profit-maximizing prices within the key-competitors' price ranges. For example, the following constraint can be included in the omni-channel price optimization method suggested in co-owned, co-pending U.S. patent application Ser. No. 14/266,297, entitled “Omni-Channel Demand Modeling And Price Optimization,” filed on Apr. 30, 2014, which is incorporated herein by reference in its entirety.

(1−α)pⱼ≦pᵢₘ≦(1+α)pⱼ∀m∈M, (18)

where j is a key competitor as determined by the value-at-risk and pᵢₘ is the price to be optimized. Here α is a constant and it denotes the maximum percentage deviation of retailer's price from the competitor's price and thus encapsulates a key-competitive price range for a retailer.

Another example of price matching is to set prices that maximize revenue minus a penalty for the price deviating from the key competitors' prices. The penalty may be of the form:

$$λ {\sum }_{j ∈ J} {VaR}_{imj} {‖ {p}_{i m} - {p}_{j} ‖}_{2}^{2} \qquad ( 19 )$$

where λ is a chosen parameter that reflects the importance of having prices close to the key competitors' price ranges, and the penalty is proportional to the total weighted deviation from competitor prices with weights equal to the value-at-risk.

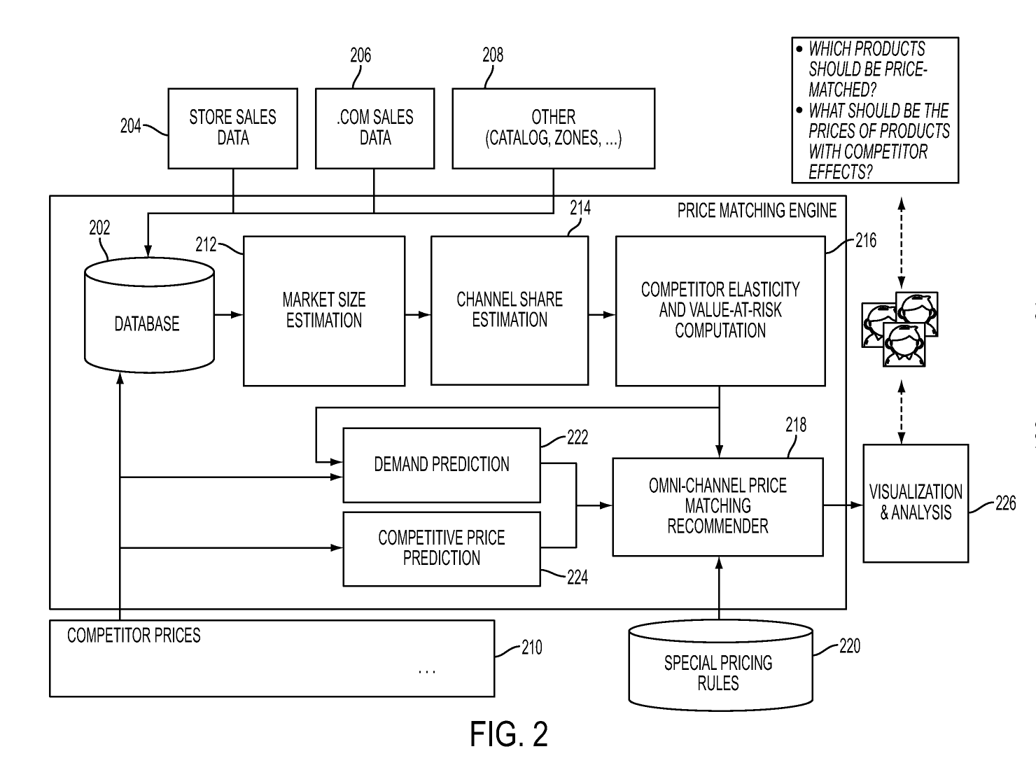

FIG. 2 is a block diagram showing the components that may implement a methodology of the present disclosure for price matching and price optimization in one embodiment. The database 202 may comprise data such as a retailer's store sales data 204, the retailer's online sale data (e.g., “.com” sales data) 206, and sales data from other sales channel 208 of the retailer. Sales data show the amount of sold product(s) as well as prices and other promotional data. The retailer (also referred to as a first seller) in this instance is the one for whom the pricing optimization or pricing matching is performed. Other retailers are referred to herein also as competitors or second sellers (for the sake of explanation). The database 202 also includes other retailers' (e.g., competitors') prices for the same or similar the proudct(s). Market Size Estimation 212 and Channel Share Estimation 214 components may utilize the log likelihood function to calibrate a demand model, and estimate market size and channel share using the calibrated demand model, e.g., as described above with reference to calibrating a demand model. Other known algorithms may used to estimate the demand model.

Cross-competitor Elasticity and Value-at-risk Computation 216 component determines cross-competitor price elasticity, identifies key competitors (candidate competitors), e.g., based on the magnitude of the cross-competitor price elasticity and/or other criterion, and computes value-at-risk values for the retailer.

Omni-Channel Price Matching Recommender 218 takes the computed cross-competitor price elasticity and value-at-risk values and performs price matching recommendataion. The recommendation may identify one or more products to price match. In one aspect, price matching recommendation may be for a specific sales channel. The recommendation may also determine a price for the product. In one aspect, the recommendation may provide the price for the product for a specific sales channel. In one aspect, Omni-Channel Price Matching Recommender 218 may recommend price matching based on one or more special pricing rules 220. For instance, a threshold policy may determine one or more products for price matching using risk assessment results drawn from the value-at-risk values. An example of a special pricing rule may include determining whether a Value-at-risk exceeds a predefined threshold value, e.g., described above, e.g., with reference to FIG. 3. Other pricing rules may be specified that utilizes one or more value-at-risk values.

In another aspect, Omni-Channel Price Matching Recommender 218 may recommend optimized price matching based on an algorithm, e.g., described above with reference to Equations (18) and (19). Other optimizing algorithms may be utilized. For providing optimum price matching, Omni-Channel Price Matching Recommender 218 also receives demand prediction data from Demand Prediction 222 component and competitive price prediction data from Competitive Price Prediction 224 component. Demand Prediction 222 component may predict demand for a product (or product category) using the calibrated demand model, e.g., Equation (2). Thus, e.g., Demand Prediction 22 component may estimate future sales associated with one or more products for the retailer. Competitive Price Prediction 224 component may predict competitor's price, e.g., based on one or more of available algorithms, e.g., time series computation, regression analysis, and/or others. Thus, e.g., Competitive Price Prediction 224 component may compute future prices associated with one or more products for one or more identified competitors (also referred to as candidate competitors) at 216. Prices for one or more products for the retailer may be determined based on the value at risk, the future prices associated with said one or more products for one or more candidate competitors and the future sales associated with one or more products for the retailer such that those prices are within a competitive price range of one or more candidate competitors.

Visualization and Analysis 226 provides user interface visualization, e.g., shown in FIG. 3 and FIG. 4, and enables a user 228 to analyze price matching based on the visualization. As described above, FIG. 3 illustrates an example visualization that shows revenue-at-risk displayed by product, sales channel, and competitor. FIG. 4 illustrates another example visualization that shows revenue-at-risk contributed by each sales channel and competitor for a retailer's product category whose total revenue-at-risk due to competition is $1,000,000. Visualization and Analysis 226 component may graphically display value-at-risk metrics from different competitors, the value-at-risk metrics computed using cross-competitor elasticity, which may take into account the joint impact of a plurality of competitor price movements in the marketplace on product sales.

Market Size Estimation 212, Channel Share Estimation 214, Cross-competitor Elasticity and Value-at-risk Computation 216, Omni-Channel Price Matching Recommender 218, Demand Prediction 222 and Competitive Price Prediction 224, and Visualization and Analysis 226 components may be computer executable components that run on one or more hardware processors such as a central processing unit or a specialized processor. Database 202 may comprise data stored on a storage device, e.g., accessible via a database application or another program interface. Special Pricing rules also may be predefined and stored in memory or another storage device, accessible by Omni-Channel Price Matching Recommender 218 component.

The methodolgoy and system of the present disclosure in one embodiment may systematically (e.g., and dynamically) identify key competitors (candidate competitor) whose product prices should be matched, also determine which products should be price-matched, and the prices of products with competitor effects. The inputs to the methodolgoy and system may comprise the seller's sales and transaction data, and competitor price data. In one aspect, the methodology of the present disclosure does not assume availability of both price and sales data from all competitors, e.g., the methodology may estimate demand only having access to historical competitor price data. In one aspect, there is no restriction on the number of cmpetitors, and any competitor may be included in the analysis (that identifies candidate competitors, products and computes prices), e.g., if price data for that competitor is available. As new data is received, cross-competitor price elasticity values may be updated and updated value-at-risk metrics may be computed. The methodology and system of the present disclosure isolates the key competitors (candidate competitors) in a market whose prices impact the seller's sales. The key competitors identified by the methodology of the present disclosure may vary between products or product categories, and channel. For example, the identified key competitors are different by product.

Rather than to have a fixed set of competitors to price match against, regardless of the product category or product, the methodology of the present disclosure in one embodiment quantifies (per product or per product ateogry) the value-at-risk due to a specific competitor (e.g., the total product revenue at risk to competitor price changes). For instance, not all competitors may be the same, since some competitors might have only small effect on a seller's sales, but some competitors may pose a risk. The methodology of the present disclosure may use sales data and competitor price data for such effects and product value-at-risk as a metric for determining price matching strategies. In another aspect, the methodology may visualize such value-at-risk metric as a tool to aid users in making stategic decisions. An example visual allows a user to compare value-at-risk across products, product categories, and competitors. Further, using value-at-risk metrics, the impact of competitor price changes for a product may be ranked.

While the above description referred to a retailer, it should be understood that the methodology may apply to any seller of one or more products. In the claims, the terms “first” and “second” with respect to a seller are used only to differentiate one seller from another seller. Those terms do not denote any order or impart any other meaning.

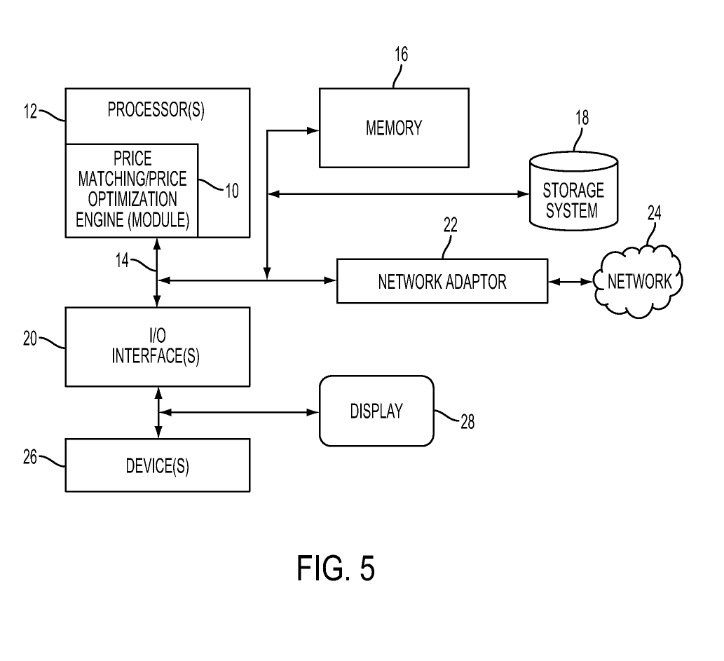

FIG. 5 illustrates a schematic of an example computer or processing system that may implement a price matching system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method for price matching in a marketplace with a first seller and one or more second sellers selling one or more products, comprising:
obtaining a first seller's sales data and price data associated with said one or more products in one or more sales channels;
obtaining one or more second sellers' price data associated with said one or more products in said one or more sales channels;
calibrating, by a processor, a demand model based on the first seller's sales data and price data associated with said one or more products in one or more sales channels and said one or more second sellers' price data associated with said one or more products in said one or more sales channels;
computing simultaneously, by the processor, cross-competitor price elasticities associated respectively with said one or more second sellers based on the demand model;
identifying, by the processor, one or more candidate competitors in the marketplace for price matching based on the cross-competitor price elasticities;
computing, by the processor, a value at risk attributed to said one or more candidate competitors;
determining, by the processor, one or more products for price matching based on the value at risk.

2. The method of claim 1, further comprising determining one or more prices for said respective one or more products based on applying one or more predefined pricing rules to the value at risk.

3. The method of claim 1, further comprising:
computing future prices associated with said one or more products for said one or more candidate competitors;
estimating future sales associated with said one or more products for the first seller; and
determining one or more prices for said respective one or more products for said first seller based on the value at risk, the future prices associated with said one or more products for said one or more candidate competitors and the future sales associated with said one or more products for the first seller, said one or more prices being within a defined competitive price range of said one or more candidate competitors.

4. The method of claim 1, wherein the value at risk comprises at least one of volume-at-risk value, revenue-at-risk value, and profit-at-risk value.

5. The method of claim 4, wherein the value at risk are computed per product per sales channel, per product per competitor, per product per sales channel per competitor, per product category per sales channel, per product category per competitor, or per product category per sales channel per competitor, or combinations thereof.

6. The method of claim 1, further comprising providing a visualization of the value at risk associated the one or more products offered by said one or more candidate competitors.

7. A computer readable storage medium storing a program of instructions executable by a machine to perform a method of price matching in a marketplace with a first seller and one or more second sellers selling one or more products, the method comprising:
obtaining a first seller's sales data and price data associated with said one or more products in one or more sales channels;
obtaining one or more second sellers' price data associated with said one or more products in said one or more sales channels;
calibrating, by a processor, a demand model based on the first seller's sales data and price data associated with said one or more products in one or more sales channels and said one or more second sellers' price data associated with said one or more products in said one or more sales channels;
computing simultaneously, by the processor, cross-competitor price elasticities associated respectively with said one or more second sellers based on the demand model;
identifying, by the processor, one or more candidate competitors in the marketplace for price matching based on the cross-competitor price elasticities;
computing, by the processor, a value at risk attributed to said one or more candidate competitors;
determining, by the processor, one or more products for price matching based on the value at risk.

8. The computer readable storage medium of claim 7, further comprising determining one or more prices for said respective one or more products based on applying one or more predefined pricing rules to the value at risk.

9. The computer readable storage medium of claim 7, further comprising:
computing future prices associated with said one or more products for said one or more candidate competitors;
estimating future sales associated with said one or more products for the first seller; and
determining one or more prices for said respective one or more products for said first seller based on the value at risk, the future prices associated with said one or more products for said one or more candidate competitors and the future sales associated with said one or more products for the first seller, said one or more prices being within a defined competitive price range of said one or more candidate competitors.

10. The computer readable storage medium of claim 7, wherein the value at risk comprises at least one of volume-at-risk value, revenue-at-risk value, and profit-at-risk value.

11. The computer readable storage medium of claim 10, wherein the value at risk are computed per product per sales channel, per product per competitor, per product per sales channel per competitor, per product category per sales channel, per product category per competitor, or per product category per sales channel per competitor, or combinations thereof.

12. The computer readable storage medium of claim 7, further comprising providing a visualization of the value at risk associated the one or more products offered by said one or more candidate competitors.

13. A system for price matching in a marketplace with a first seller and one or more second sellers selling one or more products, comprising:
a hardware processor;
storage device operable to store a first seller's sales data and price data associated with said one or more products sold in one or more sales channels, the storage device further operable to store one or more second sellers' price data associated with said one or more products sold in said one or more sales channels,
the hardware processor operable to calibrate a demand model based on the first seller's sales data and price data associated with said one or more products in one or more sales channels and said one or more second sellers' price data associated with said one or more products in said one or more sales channels,
the hardware processor further operable to compute simultaneously cross-competitor price elasticities associated respectively with said one or more second sellers based on the demand model,
the hardware processor further operable to identify one or more candidate competitors in the marketplace for price matching based on the cross-competitor price elasticities,
the hardware processor further operable to compute a value at risk attributed to said one or more candidate competitors, and
the hardware processor further operable to determine one or more products for price matching based on the value at risk.

14. The system of claim 13, wherein the hardware processor is further operable to determine one or more prices for said respective one or more products based on applying one or more predefined pricing rules to the value at risk.

15. The system of claim 13, wherein the hardware processor is further operable to compute future prices associated with said one or more products for said one or more candidate competitors, estimate future sales associated with said one or more products for the first seller, and determine one or more prices for said respective one or more products for said first seller based on the value at risk, the future prices associated with said one or more products for said one or more candidate competitors and the future sales associated with said one or more products for the first seller, said one or more prices being within a defined competitive price range of said one or more candidate competitors.

16. The system of claim 13, wherein the value at risk comprises at least one of volume-at-risk value, revenue-at-risk value, and profit-at-risk value.

17. The system of claim 16, wherein the value at risk are computed per product per sales channel, per product per competitor, per product per sales channel per competitor, per product category per sales channel, per product category per competitor, or per product category per sales channel per competitor, or combinations thereof.

18. The system of claim 13, wherein the processor is further operable to provide a visualization of the value at risk associated the one or more products offered by said one or more candidate competitors.
